(19) United States
(12) Patent Application Publication
(10) Pub. No.: US 2012/0066122 A1
(43) Pub. Date: Mar. 15, 2012

(54) Digital Currency Gift Cards and Their Methods of Production

(76) Inventor: Robert H. Goldberg, Santa Monica, CA (US)

(21) Appl. No.: 13/081,973

(22) Filed: Apr. 7, 2011

Related U.S. Application Data
(60) Provisional application No. 61/383,239, filed on Sep. 15, 2010.

(51) Int. Cl. G06Q 20/36

(52) U.S. Cl. 705/41

(57) ABSTRACT

Gift cards and/or placards as disclosed herein include: a) a card, placard or combination thereof, b) a graphic design related to the use of the card, placard or combination thereof, and c) a designated PIN space on the card, placard or combination thereof. Methods of producing a gift card for use in online environments are also described that includes: a) providing a card, placard or combination thereof that includes a PIN space, b) providing a printing apparatus, c) providing an individual PIN number; and d) using the printing apparatus to print the individual PIN number in the PIN space.

This application is a United States Utility Application that claims priority to United States Provisional Application Ser. No.: 61/383239 filed on Sep. 15, 2010, which is commonly-owned and incorporated herein in its entirety by reference.

### BACKGROUND

The design and function of gift cards is rapidly evolving to meet a significant demand by consumers. For example, gift cards can be purchased online or in stores, can be real or virtual and can be given in person or by electronic mail (E-mail).

One type of gift card is designed to provide someone with the ability to purchase various items to be used in online game play. For example, $20 may purchase 200 Facebook™ Credits on www.facebook.com or Facebook, a digital currency to be used in the game Sorority Life™ on Facebook™. These Facebook™ Credits are used to purchase virtual clothing, virtual accessories, virtual transportation and other items to be used in that game. Similar types of virtual items and virtual land can be purchased using points or scrip in other games, such as Farmville™, Mafia Wars™, Tiki Land™ and other games in the Facebook™ space. There are similar games on other social media sites or online where cash is used to purchase a particular amount of game-related scrip that is then used in the game. It is likely that, given the popularity of the current games, that additional games for conventional social media sites, along with new social media sites, will be developed and directed at targeted users.

Many stores, such as Best Buy and Target carry gift cards with designated dominations, such as $10, $25 and $100. With the pin code on the back of the card being entered into the social media or gaming website, these Digital Currency Cards™ may allow the user to use the money to buy scrip in a particular online game, in a particular group of games produced by one company (e.g. Gala-Net), or on a particular gaming platform like Facebook™.

Certain cards do not have the pin code/product key printed on the back of the card itself, but instead print the live (active and working) code on the register tape at the point of sale. For example, a purchaser may want to buy a $50 digital currency gift card for his brother at a retailer such as Gamestop™. The purchaser would then go up to the counter with the card and notify the clerk of the intent to purchase. The clerk completes the transaction and a pin code/product key is printed out of the register on the receipt. The purchaser would then need to give the receipt to his brother, along with the card, for his brother to be able to use the $50 in that game or on that website.

The lack of flexibility in the second before-mentioned scenario has provided a void whereby a new type of card or system can be provided that both allows a purchaser to purchase a tangible card and to give the card to a giftee without including the receipt—thereby making the card the only item given to the giftee. This type of new card or system would be ideal to develop.

### SUMMARY

Gift cards and/or placards as disclosed herein include: a) a card, placard or combination thereof, b) a graphic design related to the use of the card, placard or combination thereof, and c) a designated PIN space on the card, placard or combination thereof.

Methods of producing a gift card for use in online environments are also described that includes: a) providing a card, placard or combination thereof that includes a PIN space, b) providing a printing apparatus, c) providing an individual PIN number; and d) using the printing apparatus to print the individual PIN number in the PIN space.

### BRIEF DESCRIPTION OF THE FIGURES

FIG. 1 shows a contemplated embodiment of a gift card.

FIG. 2 shows a contemplated embodiment of a gift card.

### DETAILED DESCRIPTION

A new card and related system have been developed that allow for ultimate flexibility for the purchaser and giftee. Current embodiments allow a purchaser to purchase a tangible card, allow the purchase to designate the value for the card and allow the purchaser to give the card to a giftee without including the receipt—thereby making the card the only item given to the giftee. In some embodiments, a portion of the receipt containing the personal identification number or PIN number can be included on contemplated cards or placards by various methods.

Specifically, contemplated gift cards and/or placards include: a) a card, placard or combination thereof, b) a graphic design related to the use of the card, placard or combination thereof, and c) a designated PIN space on the card, placard or combination thereof. In contemplated embodiments, the designated PIN space on the card, placard or combination thereof is designed specifically for a PIN number or another code that is directly related to the use of the card, placard or combination thereof.

In contemplated embodiments, the graphic design related to the use of the card, placard or combination thereof is designed to show the purchaser and the giftee what the card, placard or combination thereof can be used for, including online gaming, online purchases or a combination thereof. The graphic design may include any suitable text, suitable designs, colors and textures and it is directly related to intended use of the card, placard or combination thereof.

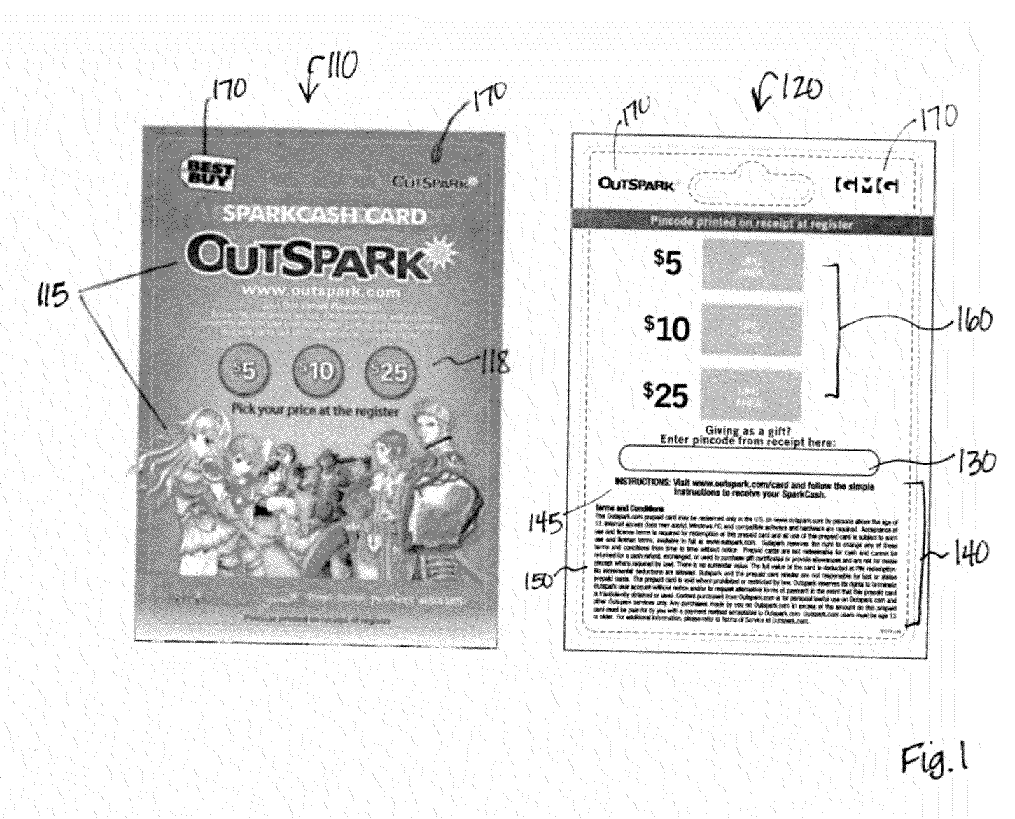

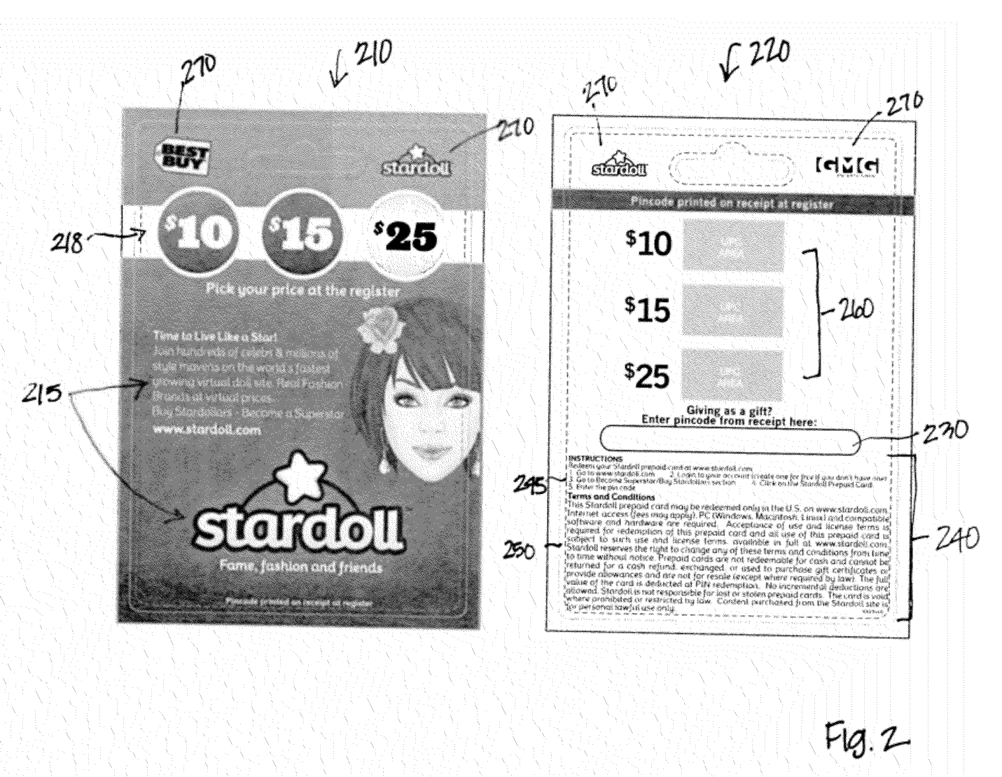

FIGS. 1 and 2 show two contemplated embodiments of a new gift card that is available for purchase at any location that sells other gift cards.

FIG. 1 shows a contemplated gift card having a front side 110 and a back side 120. The front side 110 comprises a plurality of graphics 115 designed to indicate to the purchaser/consumer (not shown) what the card can be utilized for. There is also at least one graphic indicator 118 that provides the purchaser/consumer (not shown) what currency denominations may be associated with the card. In some embodiments, as discussed, the denomination may be freely chosen by the purchaser, such as $45 or $150, in that it is not an option on the front 110 of the card. The back side 120 of a contemplated card comprises a plurality of information and indicators, including a designated PIN space 130, an information section 140, which may include instructions 145 or terms and conditions 150, and an area to purchase a predesignated currency assignment for the card 160. There may also be some branding 170 on the front side 110 or back side 120 of the card.

FIG. 2 shows a contemplated gift card having a front side 210 and a back side 220. The front side 210 comprises a plurality of graphics 215 designed to indicate to the purchaser/consumer (not shown) what the card can be utilized for. There is also at least one graphic indicator 218 that provides the purchaser/consumer (not shown) what currency denominations may be associated with the card. In some embodiments, as discussed, the denomination may be freely chosen by the purchaser, such as $45 or $150, in that it is not an option on the front 210 of the card. The back side 220 of a contemplated card comprises a plurality of information and indicators, including a designated PIN space 230, an information section 240, which may include instructions 245 or terms and conditions 250, and an area to purchase a predesignated currency assignment for the card 260. There may also be some branding 270 on the front side 210 or back side 220 of the card.

When a purchaser buys one of these cards a code is provided by the computer that corresponds to the game card and the card amount. The purchaser can print, write or otherwise show the code by sliding the register tape into the back of the card itself and/or directly on the card or placard.

One feature of these new cards or placards is that they allow the purchaser to write or print the code on the back of the card or placard using whatever printer the purchaser has at home or at work. The purchaser can go to the website listed on the back of the card or placard and download the software application that matches the purchaser's printer. This software will pull up a virtual image of the card whereby the purchaser can type in the code from the receipt into a box on the virtual image of the card. The purchaser then puts the placard into the printer and the code prints in the code box on the actual card.

In some embodiments, the store may have a printer program that will put the code on the placard or card at the register, instead of sending it home blank with the purchaser. Obviously, this “at register” printing process would be especially helpful for those purchasers who buy last minute gifts and do not have time to take it home to be printed. It would also be a beneficial embodiment, as stores begin to move away from printed register tape—such as the Apple™ store, where your receipt can be E-mailed to you instead of printed in the store.

In other embodiments, where a store E-mails your receipt to you, the E-mail would contain a link that enables the purchaser to print the code listed on the receipt onto the card or placard. This link may direct the purchaser to a website where the purchaser would select his/her type of printer in order to line the code up on the placard correctly.

In yet other embodiments, the cashier may have an on-site printer that prints the placard code on a removable label that can be adhesively affixed to the back of the placard or card in the designated space.

In additional embodiments, the placard or card may have an adhesive strip located on some point of the placard or card, where the receipt or portion of the receipt with a PIN number may be adhesively affixed to the placard or card. It is contemplated that the adhesive strip will have a removable cover such that the adhesive strip is not exposed before the purchaser wants to affix the receipt or portion of the receipt. Some contemplated embodiments may supplement or replace the adhesive strip with die cuts that are designed to secure the receipt or portion of the receipt with a PIN number.

In all of these instances, the purchaser can determine how much money is put on the card, instead of purchasing cards with predetermined currency amounts on them. This also saves the purchaser from having to buy multiple cards in order to give a larger gift to a giftee.

In another embodiment, the purchaser can give the giftee the card with the PIN number and register the PIN number. For future gifts, the purchaser can enter and/or register the PIN number at the gaming website, companion website or company website and remotely add money to the card, so that additional cards do not need to be purchased.

Methods of producing a gift card for use in online environments are also described that includes: a) providing a card, placard or combination thereof that includes a PIN space, b) providing a printing apparatus, c) providing an individual

PIN number; and d) using the printing apparatus to print the individual PIN number in the PIN space.

Thus, specific embodiments and applications of digital currency gift cards and their methods of production have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A gift card for use in online environments, comprising:
a card, placard or combination thereof,
a graphic design related to the use of the card, placard or combination thereof, and
a designated PIN space on the card, placard or combination thereof.

2. The gift card of claim 1, wherein the graphic design is related to an online game, an online store or a combination thereof.

3. The gift card of claim 1, wherein the graphic design includes any suitable text, suitable designs, colors and textures.

4. The gift card of claim 1, wherein the graphic design is directly related to the intended use of the card, placard or combination thereof.

5. The gift card of claim 1, wherein the designated PIN space comprises an adhesive material, at least one die cut or a combination thereof.

6. The gift card of claim 1, wherein the designed PIN space comprises a printed PIN number.

7. The gift card of claim 6, wherein the printed PIN number is affixed in the designated PIN space.

8. The gift card of claim 7, wherein the printed PIN number is adhesively affixed in the designated PIN space.

9. The gift card of claim 6, wherein the printed PIN number is registerable on a companion website.

10. A method of producing a gift card for use in online environments, comprising:
providing a card, placard or combination thereof that includes a PIN space,
providing a printing apparatus,
providing an individual PIN number; and
using the printing apparatus to print the individual PIN number in the PIN space.

11. The method of claim 10, wherein the graphic design is related to an online game, an online store or a combination thereof.

12. The method of claim 10, wherein the graphic design includes any suitable text, suitable designs, colors and textures.

13. The method of claim 10, wherein the graphic design is directly related to the intended use of the card, placard or combination thereof.

14. The method of claim 10, wherein the designated PIN space comprises an adhesive material, at least one die cut or a combination thereof.

15. The method of claim 10, wherein the designed PIN space comprises a printed PIN number.

16. The method of claim 15, wherein the printed PIN number is affixed in the designated PIN space.

17. The method of claim 16, wherein the printed PIN number is adhesively affixed in the designated PIN space.

18. The method of claim 15, wherein the printed PIN number is registerable on a companion website.
